(19) United States
(12) Patent Application Publication
(10) Pub. No.: US 2008/0179012 A1
(43) Pub. Date: Jul. 31, 2008

(54) Reversable transmission mechanism for laminator, laminator having same

(75) Inventor: Chuang-Mu Chiu, Taipei Hsien (TW)

Correspondence Address: BIRCH STEWART KOLASCH & BIRCH, PO BOX 747, FALLS CHURCH, VA, 22040-0747, US

(73) Assignee: TEX YEAR INDUSTRIES INC.

(21) Appl. No.: 11/700,159

(22) Filed: Jan. 31, 2007

(51) Int. Cl. B32B 41/00

(52) U.S. Cl. 156/361

(57) ABSTRACT

A reversible transmission mechanism for laminator and laminator having same in which a motor is mounted on a spring-supported lever at one side of the laminator body for driving a transmission gear train through a pinion on the output shaft of the motor to rotate two sheet-transfer rollers, and a press member is provided for pressing by the user to bias the lever and to further change the engagement between the pinion and the transmission gear train for reversing the sheet-transfer rollers upon a paper jam.

### BACKGROUND OF THE INVENTION

1. Field of the Invention

The present invention relates to a laminator for laminating sheet members and more particularly, to such a laminator, which has a reversible transmission mechanism controllable by a spring-supported lever through a press member to reverse the sheet transferring direction of the sheet-transfer rollers thereof upon a paper jam or resistance.

2. Description of the Related Art

Laminator is an implement intensively used in schools, offices, and homes for laminating cards, photos, leaflets, and etc., with a plastic laminating film. When in use, the card, photo, or leaflet is inserted into the pocket-like laminating film and then inserted with the pocket-like laminating film into the insertion slot of the laminator. The inserted laminating film is transferred forwards through a heat sealing mechanism that sealed the laminating film. When a card, photo, or leaflet is laminated with a laminating film, it shows a sense of beauty and can be kept for long.

However, when a card, photo, or leaflet is inserted with a laminating film into a laminator obliquely, the user may be unable to pull back the laminating film from the sheet-transfer rollers of the laminator. When pulling the laminating film backwards from the sheet-transfer rollers with force at this time, the workpiece or the parts of the laminator may be damaged. When letting the obliquely inserted laminating film be transferred forwards, the card, photo, or leaflet may be damaged.

Further, different laminating films from different suppliers have different thickness, and different laminators have different laminating thickness. There are laminators that allow adjustment of the laminating thickness for allowing different thickness of workpieces to pass. However, a paper jam may occur due to many different reasons such as oblique insertion of the workpiece, excessively high thickness of the workpiece, heat resistant temperature of the laminating film, etc. When a laminating film is jammed in a laminator, the card, photo, or leaflet may be damaged, and removal of the laminating film from the laminator is also difficult.

Therefore, it is desirable to provide a reversible transmission mechanism for laminator, which allows reversing of the transfer of the laminating film upon a paper jam, preventing damage to the workpiece or parts of the laminator.

### SUMMARY OF THE INVENTION

The present invention has been accomplished under the circumstances in view. It is the main object of the present invention to provide a reversible transmission mechanism for laminator, which can be reversed to return the laminating film upon a paper jam

To achieve this and other objects of the present invention, the reversible transmission mechanism comprises a motor mounted on a spring-supported lever at one side of the laminator body for driving a transmission gear through a pinion on the output shaft of the motor to rotate two sheet-transfer rollers, and a press member for pressing by the user to bias the lever and to further disengage the pinion from the transmission gear and to force the pinion into engagement with two meshed idle gearwheels for reversing the transmission gear and the sheet-transfer rollers upon a paper jam.

### BRIEF DESCRIPTION OF THE DRAWINGS

FIG. 1 is an elevational view of a laminator according to the present invention.

FIG. 2 is an elevational assembly view of the laminator according to the present invention.

FIG. 3 is an enlarged view of a part of FIG. 2, illustrating the structure of the reversible transmission mechanism.

FIG. 4 is a schematic drawing of the present invention, illustrating forward transmission of the reversible transmission mechanism.

FIG. 5 is a perspective view of the present invention showing the status of the reversible transmission mechanism after pressing of the press member.

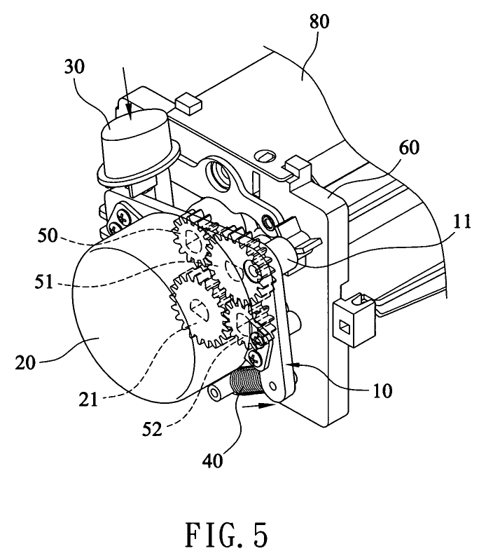

FIG. 6 is a schematic drawing illustrating backward transmission of the reversible transmission mechanism.

FIG. 7 corresponds to FIG. 2 when viewed from another angle.

### DETAILED DESCRIPTION OF THE INVENTION

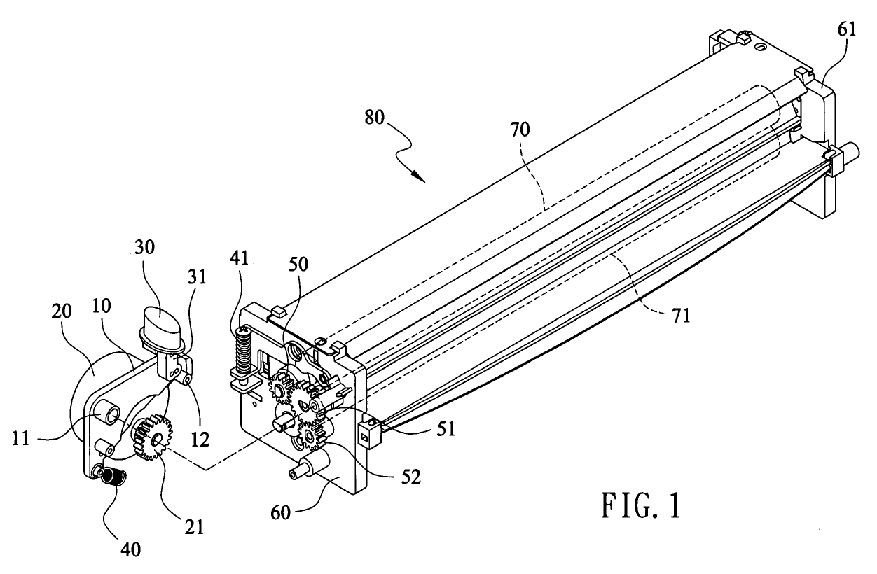

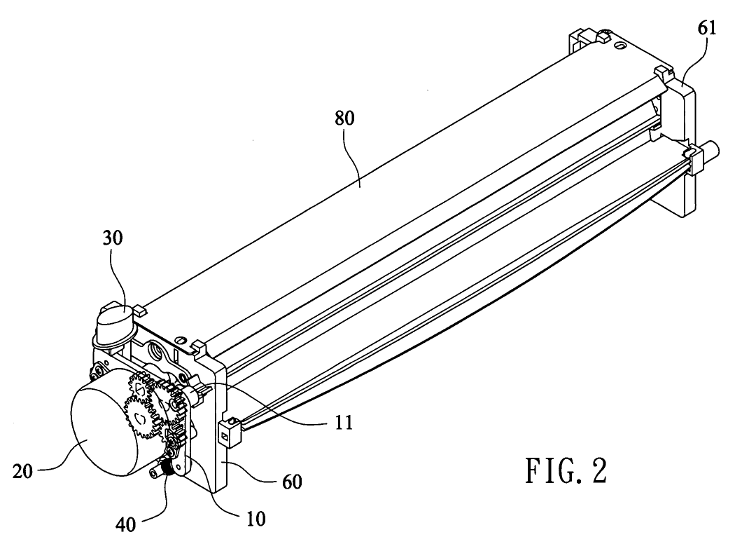

Referring to FIGS. 1 and 2, a reversible transmission mechanism in accordance with the present invention is shown installed in one side of a laminator body 80. The reversing mechanism comprises a lever 10. The lever 10 is an elongated member having a certain structural strength. Further, the installation of the lever 10 does not interfere with the operation of other parts. The lever 10 can be made having a triangular or any other profiles. According to this embodiment, the lever 10 is shaped like a L-shaped bar (see FIG. 1), having a pivot shaft 11 and a protruding block 12 protruded from its one end. A spring member 40 is connected with its one end to the other end of the lever 10, and its other end to the laminator body 80.

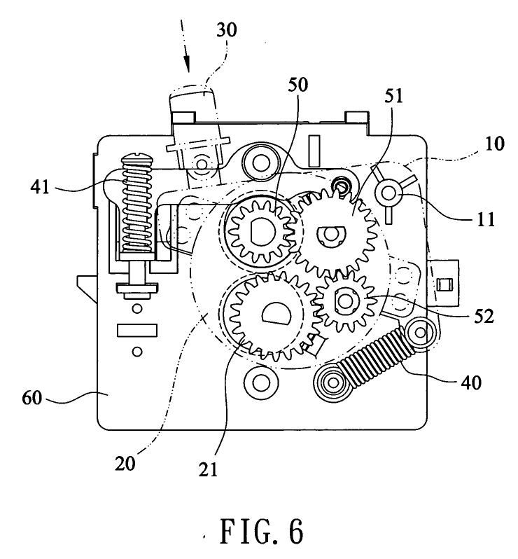

A press member 30 is connected to a rod member 31, which is stopped at one end of the lever 10 opposite to the spring member 40. As shown in FIG. 6, when an external pressure is applied to the press member 30, the lever 10 is turned about the axis of the pivot shaft 11. When the applied force is disappeared, the spring member 40 returns the lever 10 to its former position.

Further, the aforesaid spring member 40 can be a tensile spring or spring strip.

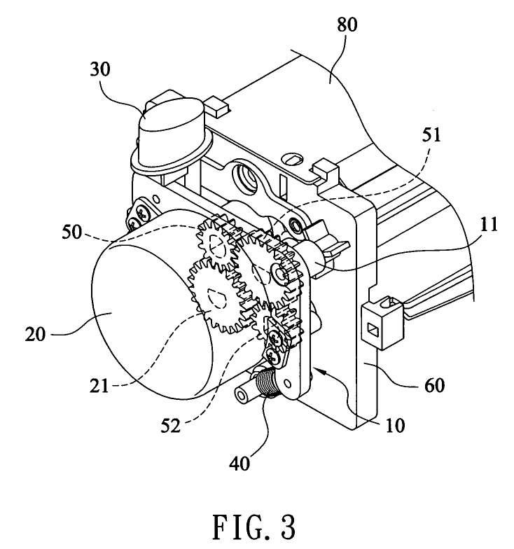

Referring to FIG. 3 and FIG. 1 again, a motor 20 is fixedly mounted on the lever 10, having a pinion 21 fixedly provided at the output shaft thereof. A bracket 60 is fixedly provided at one side of a laminator body 80. Two sheet-transfer rollers 70 and roller 71 are arranged in parallel inside the laminator body 80 for transferring a laminating film. The sheet-transfer rollers 70 and 71 each have a roller shaft (not shown) respectively and pivotally supported in the bracket 60. A transmission gear 50 is mounted on the roller shaft of one sheet-transfer roller 70. A first idle gearwheel 51 is pivotally mounted on the bracket 60 and meshed with the transmission gear 50. A second idle gearwheel 52 is pivotally mounted on the bracket 60 and meshed with the first idle gearwheel 51. Further, the press member 30 is vertically movably coupled to the bracket 60. The user can press the press member 30 to bias the lever 10.

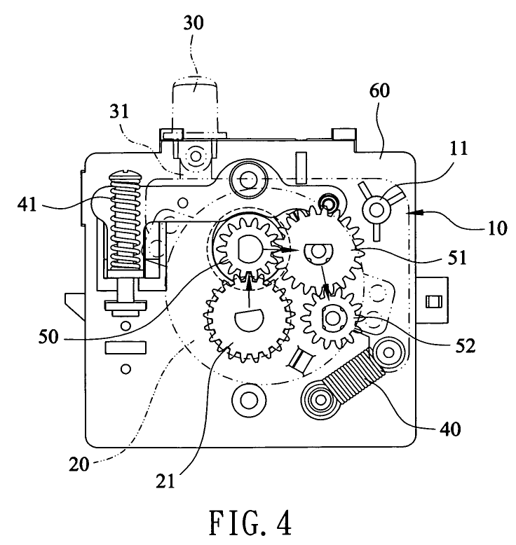

Referring to FIG. 4 and FIGS. 1 and 3 again, the pivot shaft 11 of the lever 10 is pivoted to the bracket 60. The pinion 21 of the motor 20 is meshed with the transmission gear 50. As shown in FIG. 4, when starting the motor 20, the rotary driving force of the motor 20 is transferred in proper order from the motor 20 through the pinion 21, the transmission gear 50, and the first idle gearwheel 51, and the to the second idle gearwheel 52. Because the first idle gearwheel 51 and the second idle gearwheel 52 are respectively pivoted to the bracket 60, they run idle at this time while the sheet-transfer roller 70 is rotating with the transmission gear 50 and the sheet-transfer roller 71 is been rotated in the reversed direction relative to the sheet-transfer roller 70. Under this operation mode, the sheet-transfer rollers 70 and 71 are rotated to transfer the supplied laminating film forwards.

Referring to FIGS. 1 and 3 again, when pressed the press member 30, the rod member 31 is lowered and forced against the protruding block 12, thereby turning the lever 10 about the axis of the pivot shaft 11 to disengage the pinion 21 of the motor 20 from the transmission gear 50 at the sheet-transfer roller 70 and to force the pinion 21 into engagement with the second idle gearwheel 52, as shown in FIG. 6. At this time, the rotary driving force of the motor 20 is transferred in proper order from the motor 20 through the pinion 21, the second idle gearwheel 52, and the first idle gearwheel 51, and then to the transmission gear 50 to reverse the direction of rotation of the transmission gear 50, and therefore the sheet-transfer rollers 70 and 71 are reversed to transfer the supplied laminating film backwards.

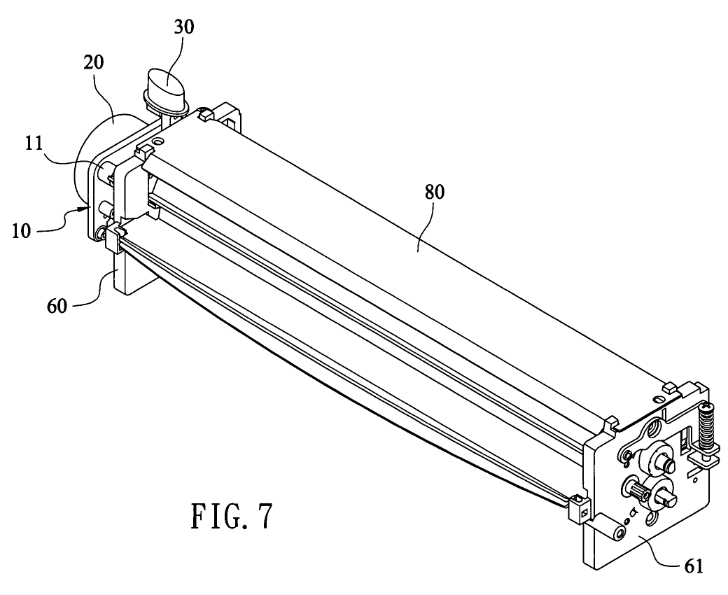

Referring to FIG. 7 and FIGS. 1 and 2 again, a second bracket 61 is fixedly mounted on the other side of the laminator body 80 to support the other ends of the roller shafts of the sheet-transfer rollers 70 and 71.

By means of the arrangement of the present invention, the user can reverse the sheet transferring direction of the sheet-transfer rollers upon a paper jam or improper feeding of a laminating film, thereby eliminating the trouble quickly and preventing potential damage. Therefore, the invention makes the use of the laminator more convenient, and extends the working life of the laminator.

Although a particular embodiment of the invention has been described in detail for purposes of illustration, various modifications and enhancements may be made without departing from the spirit and scope of the invention. Accordingly, the invention is not to be limited except as by the appended claims.

What is claimed is:

1. A reversible transmission mechanism installed in a laminator body of a laminator for rotating two sheet-transfer rollers in said laminator body to transfer a laminating film forward/backward selectively, the reversible transmission mechanism comprising:
a bracket fixedly provided at one side of said laminator body to support a roller shaft of each of said sheet-transfer rollers;
a lever, said lever having a first end, a second end remote from said first end, and a pivot shaft extended from a middle part thereof between said first end and said second end and pivoted to said bracket;
a return spring connected between the second end of said lever and said bracket;
a transmission gear fixedly mounted on the roller shaft of one of said sheet-transfer rollers outside said bracket;
a motor fixedly mounted on said lever, said motor having a pinion fixedly mounted on an output shaft thereof and meshed with said transmission gear for rotating said sheet-transfer rollers to transfer a laminating film forward;
a first idle gearwheel pivotally mounted on said bracket and meshed with said transmission gear;
a second idle gearwheel pivotally mounted on said bracket and meshed with said first idle gearwheel; and
a press member coupled to said bracket and stopped against the first end of said lever for pressing by the user to bias said lever and to further disengage said pinion from said transmission gear and to force said pinion into engagement with said second idle gearwheel for reversing said sheet-transfer rollers.

2. The reversible transmission mechanism as claimed in claim 1, wherein said lever has a triangular profile

3. The reversible transmission mechanism as claimed in claim 1, wherein said lever has a L-shaped profile.

4. The reversible transmission mechanism as claimed in claim 1, wherein said lever has a protruding block extended from the first end and stopped against said press member.

5. The reversible transmission mechanism as claimed in claim 1, wherein said return spring is a tensile spring.

6. The reversible transmission mechanism as claimed in claim 1, wherein said return spring is a spring strip.

7. A laminator comprising a laminator body, two brackets respectively fixedly provided at two opposite sides of said laminator body; two sheet-transfer rollers arranged in parallel inside said laminator body for transferring a laminating film forward/backward selectively, said sheet-transfer rollers each having a roller shaft pivotally supported between said brackets, a first idle gearwheel pivotally mounted on one of said brackets and meshed with said transmission gear, a second idle gearwheel pivotally mounted on one of said brackets and meshed with said first idle gearwheel, a transmission gear fixedly mounted on the roller shaft of one of said sheet-transfer rollers outside said brackets; and a reversible transmission mechanism, said reversible transmission mechanism comprising:
a lever, said lever having a first end, a second end remote from said first end, and a pivot shaft extended from a middle part thereof between said first end and said second end and pivoted to one of said brackets;
a return spring connected between the second end of said lever and the bracket supporting said lever;
a motor fixedly mounted on said lever, said motor having a pinion fixedly mounted on an output shaft thereof and meshed with said transmission gear for rotating said sheet-transfer rollers to transfer a laminating film forward; and
a press member coupled to the bracket supporting said lever and stopped against the first end of said lever for pressing by the user to bias said lever and to further disengage said pinion from said transmission gear and to force said pinion into engagement with said second idle gearwheel for reversing said sheet-transfer rollers.
